(19) United States
(12) Patent Application Publication
(10) Pub. No.: US 2009/0323074 A1
(43) Pub. Date: Dec. 31, 2009

(54) Fiber-based laser interferometer for measuring and monitoring vibrational characterstics of scattering surface

(76) Inventor: Leonid Klebanov, Sturbridge, MA (US)

Correspondence Address: L. Klebanov, 101 Shepard Rd., Sturbridge, MA, 01566, US

(21) Appl. No.: 12/215,659

(22) Filed: Jun. 30, 2008

(51) Int. Cl. G01B 9/02

(52) U.S. Cl. 356/477

(57) ABSTRACT

A fiber-optic laser Doppler interferometer includes a MM interferometric coupler configured with a double-clad MM fiber having a core, inner cladding and outer cladding. The core of the double clad MM fiber delivers a single mode radiation of a laser source towards a vibrating scattering surface which, in response thereto, scatters a beam launched back into the delivery fiber so that the inner cladding supports MM radiation. As a result of interferometric beating of the reference and scattered beams against each other in the MM coupler, the latter continuously outputs an amplitude-modulated signal which is not substantially affected by a speckle fading effect.

### BACKGROUND OF THE INVENTION

1. Field of the Invention

The invention relates to the field of contactless measurements and monitoring characteristics of reciprocally displaceable objects, and more particularly to a fiber-optic laser Doppler interferometer for measuring and monitoring vibrational characteristics of a scattering surface.

2. Description of the Prior Art

A variety of fiber laser-based anemometers, velocimeters and vibrometers based on the Doppler effect are known in the art. While the configuration of the known devices may insignificantly vary, there are a few characteristics indispensable to all of the devices which are important to the present disclosure and discussed hereinbelow in reference to FIG. 1.

Typically, a fiber-optic vibrometer 10 is based on the principal of superposition separate waves combined together in a way that will cause the result of their combination to have some meaningful property that is diagnostic of the original state of the waves. When two waves with the same or shifted frequencies combine, the resulting pattern is determined by the phase difference between the two waves—waves that are in phase will undergo constructive inference while waves that are out of phase will undergo destructive interference.

FIG. 1 illustrates a contactless fiber interferometer 10 operative to continuously monitor, for example, a physiological event in a human or animal, such as the movement of the body. The interferometer 10 is configured with a source of coherent light 12 connected to one arm of a fiber optic coupler 20 which is operative to split the emitted light into reference and probe light beams. The probe light beam travels along a fiber 16 via a lens 22 towards a scattering surface which, in response, scatters it. The scattered light is collected by the same lens coupling the scattered light into fiber 16 which guides the scattered light back to coupler 20 where it interferes with the reference light reflected, in turn, by the flat cleaved end of an optical fiber 14. Surface vibrations result in changes of interference pattern of light fallen on a photoelectric transducer 18 converting these changes of light intensity into changes of electrical potential. The changes of electrical potential are representative of the scattered beam as modulated by the vibration of the body. The output of the detector includes a plurality of analog output voltages corresponding to the vibrating velocity of the surface.

When the coherence length of light incident upon the surfaces becomes greater than the roughness of the surface, the scattered light beams interfere with one another. The physical manifestation of the interference includes the formation of plurality of bright and dark spots or speckles. Such a phenomenon is known to the art of interferometers as the speckle fading.

The nature of the speckling may become more apparent from the following. Light waves, which are aligned perfectly in space and time, are coherent. They will unite to increase the amplitude of the combined waveform, and thus, the intensity of laser light. On the other hand, light waves that are out of phase and opposed will subtract from the strength of the united waveform. Together, constructive and destructive interference produce the speckling. One may easily observe the speckling by shining, for example, a laser pointer on white paper or against a wall. In a short while, the person will observe small bits of relatively bright and dark light—speckles. The speckles are idle if no relative displacement between the laser and surface is observed; otherwise, the speckles move.

The scattered beams each are represented by respective amplitude and phase modulated signals. When the probe beam and surface start moving parallel to one another, the amplitude and phase noise becomes basically inseparable from the parameters of the useful scattered light beam. Accordingly, a fiber-optic interferometric device used for contactless measuring and monitoring signals representing characteristics of a surface may function inadequately. The inadequacy of measurements becomes particularly troubling when the surface is located at a substantial distance from lens 22.

Returning to FIG. 1, typically, fibers 16 and 14 each are configured from a single mode optic fiber. Single-mode (SM) fibers, supporting only a single propagation mode per polarization direction for a given wavelength, each have a relatively small core, small refractive index difference between core and cladding, and a small aperture, as well known to one of ordinary skills in the laser arts. The numerical aperture is widely used in optical systems to specify the maximum acceptance angle for light to enter the fiber. Thus, the acceptance angle can be related to the refractive indices of the core and cladding. Accordingly, when the SM fiber is used in conjunction with the speckling, a focusing lens, typically used in the device of the disclosed type, can focus only a single bright speckle on the cleaved end of the SM light delivery fiber. What happens to other bright spots? Those spots remain unaccounted for further determination of the scattered beam. In practical terms, the displacement between the SM fiber and surface results in discreet or highly amplitude-modulated signals, which correspond to only those bright speckles that indeed enter the core of the fiber creating thus an amplitude noise which may lead to the unsatisfactory signal to noise ratio. Accordingly, the known devices based on a single mode fiber configuration may not provide satisfactory results.

Moreover, some of the known systems as disclosed above are configured with a single channel requiring a complicated adjustment of the device relative to the scattering surface. As a result, a great portion of scattered beams simply is not factored in the determination of the output signal.

On the other hand, when the above-discussed device is provided with multiple channels, every channel operates in exactly the same manner as a single-channel device. Hence, the multi-channel device is associated with the same disadvantage as the discussed in reference to a single-channel device of the disclosed type.

Furthermore, each channel of a multi-channel device has a frequency shifter and laser source. However, as well known to one of ordinary skills in the fiber-optic art, these components are the most expensive and bulkiest elements of the device of FIG. 1. Accordingly, a multi-channel device is cost- and space-inefficient.

A need, therefore, exists for a laser-based contactless interferometer operative to measure and monitor vibrational characteristics of a vibrating surface and configured to overcome at least some of the disadvantages of the known prior art.

A further need exists for a fiber-based laser interferometer capable of measuring and monitoring vibrational characteristics of a scattering surface and having an interferometric fiber coupler which supports multiple propagation modes of scattered light.

Still a further need exists for a fiber-based laser interferometer capable of measuring and monitoring characteristics of a vibrating surface and having a MM double-clad delivery fiber which is configured to guide a laser light beam incident upon the surface in one direction and guide multiple propagation modes of a reflected beam scattered by the surface in a direction opposite to the one.

### SUMMARY OF THE INVENTION

These needs are satisfied by a fiber-based laser Doppler interferometer configured in accordance with the disclosure. In particular, the disclosed interferometer includes, for example, a semiconductor laser generating a coherent light beam which, while propagating along a light path, is split into probe and reference signals further guided along respective fibers. The probe signal is incident upon the surface to be investigated and is further scattered as a scattered beam thereform only to be collected by focusing optics into a further fiber. The fibers, guiding respective reference and scattered beams, form an optic coupler in which the signals are optically combined. The combined signal is then delivered by still a further fiber to a photodetector operative to measure interferometric beating between the two signals in conjunction with software executed by a processor.

In accordance with the disclosure, the fibers guiding the respective reference and scattered light beams along a downstream stretch of light path are configured to support multiple propagation modes per polarization direction for a given wavelength. Coupled together in a MM coupler the MM fibers thus support propagation of multiple modes. The MM configuration of the coupler allows for coupling of much more scattered light than the known SM configuration. As a consequence, the combined signal delivered to a photodetector is not substantially affected by a specular-fading effect. Thus, using the MM coupler, the resulting signal is less amplitude modulated by the vibrations of the surface than that one of the SM configuration. In lay terms, the signal to noise ratio in the MM configuration is substantially higher than that one of the known SM configuration which, in turn, means a reliable determination of the useful signal.

Furthermore, even in the ideal case of aberration-free optics, it may be physically impossible to couple the light scattered from the scattering surface to be investigated back into a single-mode fiber coupled to the interferometric coupler without a significant loss of optical power. This limited entry of light is directly correlated to a small core diameter and small acceptance angle characteristic of a SM fiber.

In contrast, the disclosed MM configuration of fibers, particularly a delivery fiber which is juxtaposed with the surface to be investigated and guides the scattered light to the MM coupler, does not impose strict requirements on the quality of output optics which is operative to collect scattered light (disperse beams) into the multi-mode fiber without substantial losses.

### BRIEF DESCRIPTION OF THE DRAWINGS

The above and other features and advantages of the disclosed interferometer will become more readily apparent from the specific description thereof provided in conjunction with the following drawings, in which:

FIG. 1 is a diagrammatic view of interferometer typical to the known prior art.

FIG. 2 is a diagrammatic view of a fiber-optic laser Doppler interferometer configured in accordance with one of the disclosed embodiments.

FIG. 3 is a diagrammatic view of a fiber-optic laser Doppler interferometer configured in accordance with another one of the disclosed embodiments.

FIG. 4 is a front elevated view of a double-clad MM fiber delivering a laser light beam to the surface to be investigated and guiding a scattered beam light from the surface.

FIG. 5 is a diagrammatic view of a fiber-optic laser Doppler configured with still a further embodiment.

FIG. 6 graphically illustrates the operation of the disclosed fiber Doppler interferometer.

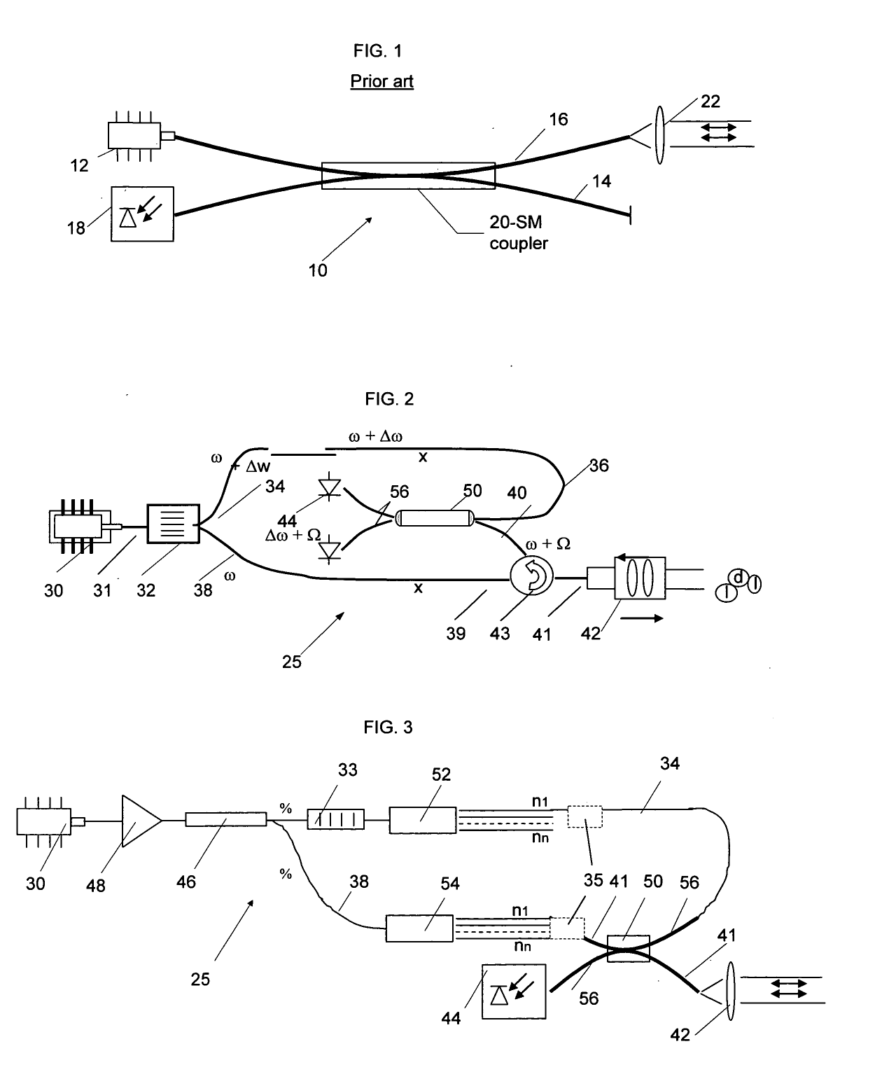

### SPECIFIC DESCRIPTION

Reference will now be made in detail to the disclosed interferometer. Wherever possible, same or similar reference numerals are used in the drawings and the description to refer to the same or like parts. The drawings are in simplified form and are far from precise scale. For purposes of convenience and clarity only, the terms “connect,” “couple,” and similar terms with their inflectional morphemes do not necessarily denote direct and immediate connections, but also include connections through mediate elements or devices. The following detailed description discloses an interferometer used for continuously monitoring of a physiological event in a human or animal; however, one of ordinary skills in the interferometric arts readily realizes that the disclosed structure can be utilized in a variety of technological fields requiring continuous monitoring of an oscillating object.

FIG. 2 illustrates the disclosed interferometer configured, for example, as non-contact stethoscope 25. The stethoscope 25 can be successfully used in a variety of technological fields including, for example, medicinal fields which require monitoring for signs of lung congestion and heart murmurs. A light source 30 of coherent light, configured, for example, as a fiber-pigtailed laser diode, is operative to emit a laser beam propagating at a frequency “w” along an upstream of light path along an upstream fiber 31 towards a beam splitting unit. Besides the laser diode, source 30 can be selected from He—Ne (helium neon) laser; fiber optic DFB (distributed feedback) or any laser generating two close spectral lines.

The beam splitting unit receiving the laser light is operative to output a reference light signal and a probe light signal propagating at respective frequencies “w+Δw” and “w” or conversely along respective reference and probe downstream waveguides. The lightguide supporting propagation of the probe signal may be configured with a plurality of sequentially located optical fibers 38 and 39, respectively, delivering the probe signal via an isolator 43 to a delivery fiber 41. The isolator 43 may be selected from a coupler or circulator and, while preventing the probe light beam signal from backreflecting along fibers 39 and 38, launches the probe signal into delivery fiber 41. The optics 42 focuses the probe signal so that it is incident upon the scattering surface to be investigated. As a result, a scattered light beam, reflected from the surface back to optics 42, is coupled again into delivery fiber 41 which guides it at frequency “w” in a reverse direction towards isolator 43. The latter, while preventing the scattered beam from entering fiber 39, substantially losslessly couples this scattered beam into an input MM fiber 40 launching it, in turn, into interferometric coupler 50.

The other lightguide, including a fiber 34 and a MM downstream fiber 36 spliced together in the end-to-end configuration, guides the reference beam towards interferometric coupler 50 so that the reference and scattered beams co-propagate therealong in the reverse direction. While co-propagating, the reference and scattered beams beat against one another in interferometric coupler 50.

Interference between the reference and probe beams in coupler 50 provides for a resulting optical signal which is amplitude-modulated by the scattering surface vibration. This resulting signal is then detected by a differential photodetector module 44 which may include pin photodiode, avalanche photodiode, two photodiodes coupled in the differential circuit and others. The output of differential photodetector module 44 is further amplified in an RF amplifier module (not shown) and detected in an FM demodulator module (not shown) producing an output. Thus, the resulting light signal is converted into an amplitude-modulated electric signal that, upon processing, is indicative of the vibrational parameters of the scattering surface.

The knowledge of the directional displacement of the scattered surface is important for restoring the initial light signal and, thus, for the correct assessment of the surface vibrational parameters. To determine the direction of the surface displacement, the splitting unit is configured as an acousto-optic modulator (AOM) also known as frequency shifter 32. An acousto-optic modulator uses the acousto-optic effect to diffract and shift light frequency “w” at a “w+Δw” frequency using sound waves usually at radio-frequency, as is the case here. Hence, the reference (or probe) beam exiting shifter 32 propagates along fibers 34 and 36 at the “w+Δw” frequency. The shifter 32 may also be configured as a piezo-stretcher phase modulator, electro-optic planar phase modulator or semiconductor optical amplifier all operating in the same manner if utilized in a Doppler-based interferometric system.

In accordance with one aspect of the disclosure, interferometric coupler 50 has a multi-mode (MM) structure. As a consequence, fibers 36, 40, and 56 associated with respective shoulders of the coupler each have a MM configuration. The MM configuration of these components is important for the reasons disclosed immediately below.

When the probe light beam, delivered by fiber 41, is focused on the scattering surface to be investigated, an array of dark “d” and light “l” speckles is formed in space between optics 42 and the surface. As the surface and lightguide are displaceable relative to one another, in case of a single mode configuration of delivery fiber 41, only one light speckle at a time enters fiber 41 supporting propagation of a single mode. The reasons for the limited entry of light into a SM fiber include a small core diameter and small acceptance angle of the SM fiber. The dark spot corresponds to no signal at all or a very weak one. As a consequence, the presence and absence of light speckles—speckle fading—coupled into a SM fiber and hitting photodetector 44 are associated with a substantial loss of power and, as a result, inadequate measurements representing the vibrational parameters of the scattering surface.

In contrast, a much more reliable result would be obtained if light enters delivery fiber 41 substantially continuously. This is attained by a MM configuration of delivery fiber 41 which typically has a large aperture and acceptance angle. Accordingly, the scattered beam enters the MM fiber substantially continuously, because at any given time, a few light speckles are launched into the MM fiber. The scattered light is further launched into MM coupler 50, where it beats against the reference signal so that a resulting signal, outputted by coupler 50, impinges upon photodetector 44. The resulting light guided along MM output fibers 56 towards the photodetector may be brighter or darker, i.e. the light power may vary, but it is continuously detected.

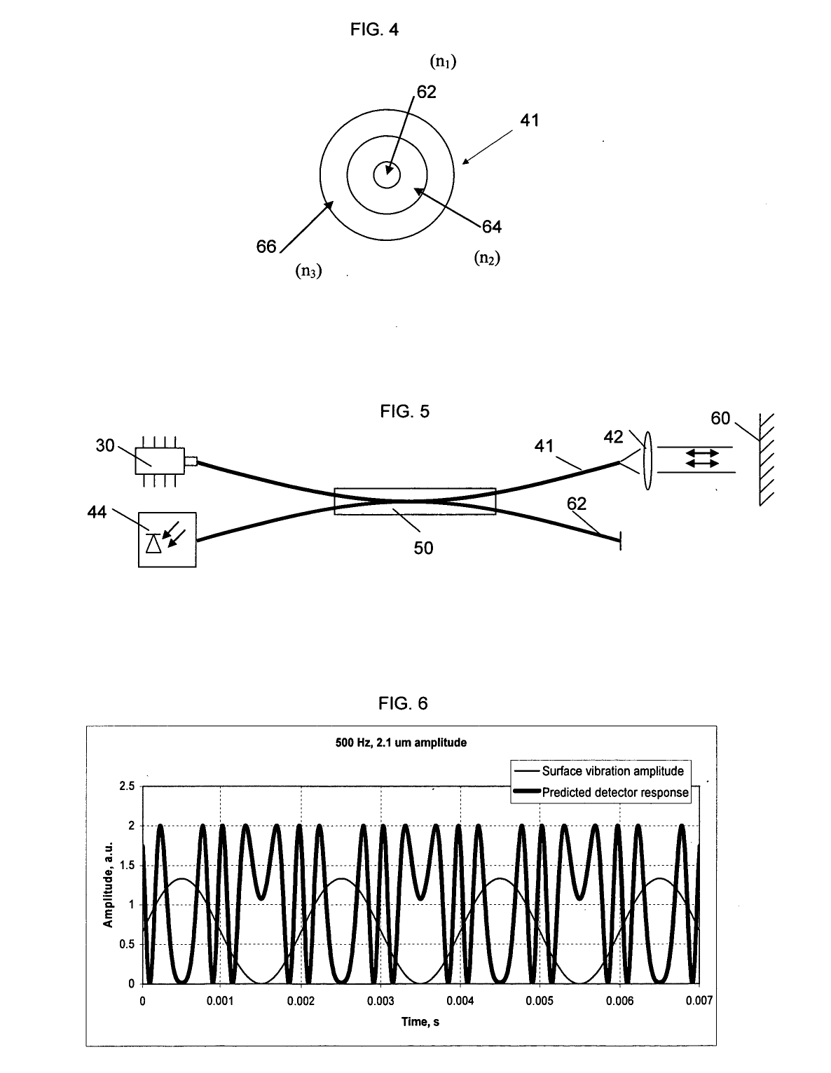

FIG. 4 illustrates a further aspect of the disclosure concerning with downstream fiber 41 of FIG. 2. As readily realized by one of ordinary skills in the laser arts, one of the advantages of the single mode fiber configuration includes a diffraction-limited beam. To combine this advantage of the SM design with the advantages of the MM design, as disclosed above, fiber 41 is configured as a double clad MM fiber. This configuration includes a core 62, an inner cladding 64 and an outer cladding 66 having respective indices n₁, n₂ and n₃ selected so that n₁>n₂>n₃. The principle of operation of double clad fiber 41 allows core 62 to support a single mode radiation of laser light without its coupling to higher modes which propagate in inner cladding 64. Thus, the probe light exiting AOM 32 may be initially guided along a SM or double-clad MM fiber 38 and further coupled into double clad MM delivery fiber 41 delivering the probe light beam to optics 42 without degradation of the mode-field profile. This increases a distance range at which the disclosed device may effectively operate. On the other hand, the scattered light is launched into double clad MM fiber 41 by optics 42 so that inner cladding 64 supports MM radiation associated with more power. Accordingly, while the operating range is substantially increased, the loss of power of scattered light guided through double-clad MM fiber 41, isolator 43, and MM input fiber 40 is insignificant.

FIG. 3 illustrates a modification of disclosed device 25. It should be readily realized that the embodiment of FIG. 3 has the same inventive features as the embodiment of FIG. 2. In particular, delivery fiber 41 is configured as a double-clad MM fiber, whereas interferometric coupler 50 has a MM configuration.

The structure illustrated in FIG. 3 includes a plurality of channels. The light source 30 emits a coherent light which may or may not be further boosted up in amplifier 48. Propagating along a light path, the coherent light is coupled into an upstream beam-splitting unit, which, in contrast to the embodiment of FIG. 2, has multiple components. Specifically, the beam splitting unit has a beam splitter 46 which is configured to output reference and probe light signals. The percentage of the power of the output light beams may vary, but typically, the output reference light constitutes the smallest portion of the input laser light. The splitting unit further has a frequency or phase shifter, for example an AOM 33, shifting the frequency of the reference (or probe) light in a manner similar to that one of FIG. 2.

A first downstream coupler 52 is located downstream from AOM 33 and operative to split the received reference beam, for example, into a plurality of n₁-nₙ channels propagating along respective MM fibers 34 towards MM interferometric coupler 50. The probe signal propagates along fiber 38 coupling it into a second downstream coupler 54 which is structured similar to first coupler 52 and operative to output a plurality of channels n₁-nₙ corresponding to respective reference channels.

The probe signal of channel n₁, for example, is further coupled into MM double clad downstream fiber 41 delivering the probe signal to optics 42, such as a lens, which operates so that the probe light is incident upon the vibrating scattering surface to be investigated. Upon reflecting, a scattered light beam again is focused by optics 42 launching this light back into double-clad MM fiber 41 which guides the scattered signal in a reverse direction towards MM coupler 50. The probe and reference signals of the same channel are combined in MM coupler 50 outputting the resulting signal through MM fiber 56 which is evaluated in photodetector module 44.

One of the structural aspects of multi-channel stethoscope 25, providing, thus, for simultaneous monitoring of multiple points of the vibrating surface to be investigated, may include single laser source 30, single AOM 33 and two couplers 52 and 54 coupled to a plurality of channels. Each channel, however, is configured with MM interferometric coupler 50 and fibers 41 and 56. The focusing optic 42 can be configured as a single component coupled to all fibers 41, or each channel may be provided with optics 42.

In accordance with a further modification of stethoscope 25, two beam switchers 35 may be incorporated in the configuration of FIG. 3 to selectively couple reference and probe beams of respective channels. In this configuration, in addition to the single laser source and shifter, interferometer 27 would also have single MM coupler 50.

Regardless of the number of channels, as mentioned above, stethoscope 25 has only one light source 30 and one AOM 32 making the disclosed device cost-effective because these two components are most expensive. In contrast, the known prior art discloses a multi-channel interferometer in which each channel has a laser and AOM. In accordance with one aspect of the disclosure, coupler 50 has a multi-mode configuration.

FIG. 5 illustrates a simple configuration of the disclosed fiber-based laser interferometer configured in accordance with still another modification of the disclosure. The illustrated interferometer has laser source 30 emitting coherent laser light which is coupled to one arm of fiber optic MM coupler 50. The MM coupler has a dual function. First, MM coupler 50 is configured to split the laser light into the reference and probe beams in any desired proportion. Second, MM coupler 50 provides for interferometric beating between a scattered light, which is scattered by surface 60 in response to the probe light incident upon the scattering surface through focusing optics 42, and the reference beam.

The scattered light is collected by same optics 42 focusing it into double-clad MM fiber 41, which also delivers the probe light to the surface, and travels back to MM coupler 50 where it interferes with the reference beam reflected by the flat cleaved end of an optical MM fiber 62. Surface vibrations result in changes of interference pattern of resulting light output by MM coupler 50 and fallen on photoelectric transducer 44. The photoelectric transducer 44 converts these changes of light intensity into changes of electrical potential further amplified by a low noise electrical circuit (not shown).

FIG. 6 illustrates detection of the resulting signal (thick line) superimposed on the surface vibration amplitude (thin line) in the disclosed device of FIG. 5. The surface vibration with frequency 500 Hz and amplitude 0.2 μm were used for this model. One can see a typical interferometric pattern.

Overall, the disclosed fiber-optic lased based interferometer combines all the advantages of a fiber optic design with the high sensitivity and long range of the bulk interferometric vibration sensor. The advantages of the disclosed fiber optic interferometer include highly reliable measurement, simplicity of assembly, no need for component alignment, compact size, lower weight, lower cost, and, if necessary, ease of incorporation of additional components (acousto-optic modulator, probe beam fiber booster amplifier, object beam fiber amplifier, etc.).

Although shown and disclosed is what is believed to be the most practical and preferred embodiments, it is apparent that departures from the disclosed configurations and methods will suggest themselves to those skilled in the art and may be used without departing from the spirit and scope of the invention. Accordingly, the present invention is not restricted to the particular constructions described and illustrated, but should be construed to cohere with all modifications that may fall within the scope of the appended claims.

1. A fiber-optic laser Doppler interferometer for measuring vibrational parameters of a scattering surface, comprising a multi-mode (MM) interferometric coupler configured to provide interferometric beating between a scattered beam, which is scattered by the scattering surface upon being impinged by a probe beam, and a reference beam so as to output a resulting signal indicative of the vibrational parameters of the scattering surface.

2. The fiber-optic laser interferometer of claim 1 further comprising a delivery fiber guiding the probe beam towards the scattering surface in one direction and the scattered beam towards the MM coupler in a direction opposite the one direction, the delivery fiber having a double-clad multi-mode configuration.

3. A fiber-optic laser Doppler interferometer for continuously measuring vibration parameters of a scattering surface comprising:
a laser source emitting a laser light beam propagating along a light path;
a beam splitter unit located downstream from the light source and configured to split the laser beam into a reference beam and a probe beam, which is incident upon the scattering surface so that the scattering surface reflects a scattered beam, the reference and probe beams differing from one another by at least one physical parameter; and
a multi-mode (MM) interferometric coupler configured to provide interferometric beating between the reference and scattered beams so as to output a resulting signal indicative of the parameters of the scattering surface.

4. The fiber-optic laser Doppler interferometer of claim 3, wherein the MM interferometric coupler has four shoulders coupled to respective MM fibers, the MM fibers including a first fiber, which guides the reference beam from the beam splitter unit to the MM interferometric coupler, a second input fiber, which guides the scattered beam to the MM interferometric coupler and a pair of output fibers.

5. The fiber-optic laser Doppler interferometer of claim 4 further comprising a delivery fiber having one end coupled to the second MM input fiber and an opposite end juxtaposed with the scattering surface so as to receive the scattered signal, the delivery fiber having a double-clad MM configuration.

6. The fiber-optic laser Doppler interferometer of claim 5 further comprising an optical isolator coupled between the one end of the delivery fiber and the second MM input fiber and configured to prevent backreflection of the scattered beam towards the beam splitter unit.

7. The fiber-optic laser Doppler interferometer of claim 5, wherein the optical isolator is selected from the group consisting of a coupler and circulator.

8. The fiber-optic laser Doppler interferometer of claim 5 further comprising focusing optics configured to launch the probe beam onto the scattering surface and couple the scattered beam into the opposite end of the double-clad MM delivery fiber.

9. The fiber-optic laser Doppler interferometer of claim 8, wherein the focusing optic is selected from the group consisting of a lens and collimator.

10. The fiber-optic laser Doppler interferometer of claim 4, wherein the beam split unit has a shifter operative to output the probe and reference beams so that the probe and reference differ from one another by the physical parameter.

11. The fiber-optic laser Doppler interferometer of claim 10, wherein the shifter is selected from the group consisting of an acousto-optic modulator (AOM), piezo-stretcher phase modulator and electro-optic planar phase modulator.

12. The fiber-optic laser Doppler interferometer of claim 4, wherein the physical parameter is selected from the group consisting of a frequency and phase.

13. The fiber-optic laser Doppler interferometer of claim 4, wherein the beam splitter unit is configured with:
an upstream beam splitter outputting the reference and probe beams,
a shifter operative to receive and output one of the probe and reference beams characterized by the physical parameter which is selected from group consisting of a frequency and phase, and
first and second downstream couplers coupled to the shifter and upstream coupler, respectively, and operative to split the respective reference and probe beams into a plurality of light channels.

14. The fiber-optic laser Doppler interferometer of claim 13, wherein the channels each have the MM interferometric coupler having respective MM input and output MM fibers and a light detector unit coupled to one of the MM output fibers.

15. The fiber-optic laser Doppler interferometer of claim 13 further comprising first and second beam switches coupled between the respective downstream first and second downstream couplers and the shifter and operative to selectively transmit the reference and probe beams of each channel.

16. The fiber optic laser Doppler interferometer of claim 12, wherein the shifter is selected from the group consisting of an acousto-optic modulator (AOM), piezo-stretcher phase modulator and electro-optic planar phase modulator.

17. The fiber optic laser Doppler interferometer of claim 3, wherein the laser source is selected from the group consisting of a high coherence semiconductor laser, He—Ne (helium neon); fiber optic DFB (distributed feedback) laser and laser generating two close spectral lines.

18. A fiber-optic laser Doppler interferometer for measuring vibrational parameters of a scattering surface, comprising:
an interferometric coupler configured to provide interferometric beating between a scattered beam, which is scattered by the scattering surface impinged by a probe beam, and a reference beam so as to output a resulting signal indicative of the vibrational parameters of the scattering surface; and
a delivery fiber guiding the probe beam towards the scattering surface in one direction and the scattered beam towards the coupler in a direction opposite the one direction, the delivery fiber having a double-clad multi-mode configuration.

19. The fiber-optic laser Doppler interferometer of claim 18, wherein the interferometric coupler is configured as a multi-mode interferometric coupler.

20. The fiber-optic laser Doppler interferometer of claim 18 further comprising a differential photodetector module impinged upon the resulting beam and selected from the group consisting of a pin photodiode, avalanche photodiode, and two photodiodes in the differential circuit.
